(19) United States
(12) Patent Application Publication
(10) Pub. No.: US 2019/0365087 A1
(43) Pub. Date: Dec. 5, 2019

(54) MICROFIBER JACKET PAINT BRUSH

(71) Applicant: Oleg Boutorine, Brooklyn, NY (US)

(72) Inventor: Oleg Boutorine, Brooklyn, NY (US)

(21) Appl. No.: 15/997,647

(22) Filed: Jun. 4, 2018

(51) Int. Cl. A46B 17/04; B32B 5/26

(52) U.S. Cl. CPC A46B 17/04; B32B 2250/20; A46B 2200/202; B32B 5/26

(57) ABSTRACT

A microfiber jacket paint brush comprises a handle; a fasten means attached to the handle; a plurality of bristles secured with the fasten means; and a microfiber cloth configured to enclose the plurality of bristles, wherein the microfiber is configured attached to the fasten means and/or the handle.

### BACKGROUND

Brushes for painting surfaces differ greatly by price and quality. Best expensive brushes use expensive bristles and used for better quality of paint coating finish. Less expensive brushes and disposable brushes bring worse coating finish. Low quality bristles in brushes cause uneven paint finish, poor uniformity, spattering and other problems.

### BRIEF SUMMARY OF THE INVENTION

This Brief Summary is included so as to introduce, in an abbreviated form, various topics to be elaborated upon below in the Detailed Description. This Brief Summary is not intended to identify key or essential aspects of the claimed invention. This Brief Summary is similarly not intended for use as an aid in determining the scope of the claims. The invention is directed to a microfiber jacket paint brush comprising a handle; a fasten means attached to the handle; a plurality of bristles secured with the fasten means; and a microfiber cloth configured to enclose the plurality of bristles, wherein the microfiber is configured attached to the fasten means and/or the handle.

### BRIEF DESCRIPTION OF THE DRAWINGS

It should be understood that the drawings are merely representative, are not necessarily drawn to scale, and are not intended to limit the subject matter of this application.

FIG. 1 is a perspective view of one preferred embodiment of the microfiber jacket paint brush.

FIG. 2 is a perspective view of one embodiment of the paint brush where the microfiber cloth is in a partially sectional view to show the bristles inside.

FIG. 3 is a perspective view of another embodiment of the microfiber jacket paint brush where bristles are wrapped in microfiber cloth with openings on sides.

FIG. 4 is a perspective view of another embodiment of the microfiber jacket paint brush where bristles are wrapped in microfiber cloth with openings.

FIG. 5 is a perspective view of another embodiment of the microfiber jacket paint brush when microfiber cloth is affixed by hook and loop fastener, as a fastening and detaching means.

FIG. 6 is a perspective view of another embodiment of the microfiber jacket paint brush comprising a plurality of flexible strips.

FIG. 7 is a perspective view of another embodiment of the microfiber jacket paint brush where the microfiber jacket paint brush comprising a plurality of flexible strips with split tips.

FIG. 8 is a perspective view of another embodiment of the microfiber jacket paint brush where the microfiber jacket paint brush comprising a layer of porous fiber or microfiber.

### DETAILED DESCRIPTION

Before the present invention is described in greater detail, it is to be understood that this invention is not limited to particular embodiments described, and as such may, of course, vary. It is also to be understood that the terminology used herein is for the purpose of describing particular embodiments only, and is not intended to be limiting, since the scope of the present invention will be limited only by the appended claims.

Where a range of values is provided, it is understood that each intervening value, to the tenth of the unit of the lower limit unless the context clearly dictates otherwise, between the upper and lower limits of that range is also specifically disclosed. Each smaller range between any stated value or intervening value in a stated range and any other stated or intervening value in that stated range is encompassed within the invention. The upper and lower limits of these smaller ranges may independently be included or excluded in the range, and each range where either, neither or both limits are included in the smaller ranges is also encompassed within the invention, subject to any specifically excluded limit in the stated range. Where the stated range includes one or both of the limits, ranges excluding either or both of those included limits are also included in the invention.

Other than in the embodiment or example, or where indicated otherwise, all numbers indicating ingredient quantities and/or reaction conditions are to be understood as being modified in every instance by the word “about,” which means the ingredient quantities or reaction conditions are within 10 percent to 15 percent of the indicated value.

Unless defined otherwise, all terms used herein have the same meaning as commonly understood by one of ordinary skill in the art to which this invention belongs. Although any methods and materials similar or equivalent to those described herein can be used in the practice or testing of the present invention, some potential and exemplary methods and materials may now be described. Any and all publications mentioned herein are incorporated herein by reference to disclose and describe the methods and/or materials in connection with which the publications are cited. It is understood that the present disclosure supersedes any disclosure of an incorporated publication to the extent there is a contradiction.

It must be noted that as used herein and in the appended claims, the singular forms “a”, “an”, and “the” may also include the plural referents unless the context clearly dictates otherwise.

It is further noted that the claims may be drafted to exclude any element that may be optional. As such, this statement is intended to serve as antecedent basis for use of such exclusive terminology as “solely”, “only” and the like in connection with the recitation of claim elements, or the use of a “negative” limitation.

As will be apparent to those of skill in the art upon reading this disclosure, each of the individual embodiments described and illustrated herein has discrete components and features which may be readily separated from or combined with the features of any of the other several embodiments without departing from the scope or spirit of the present invention.

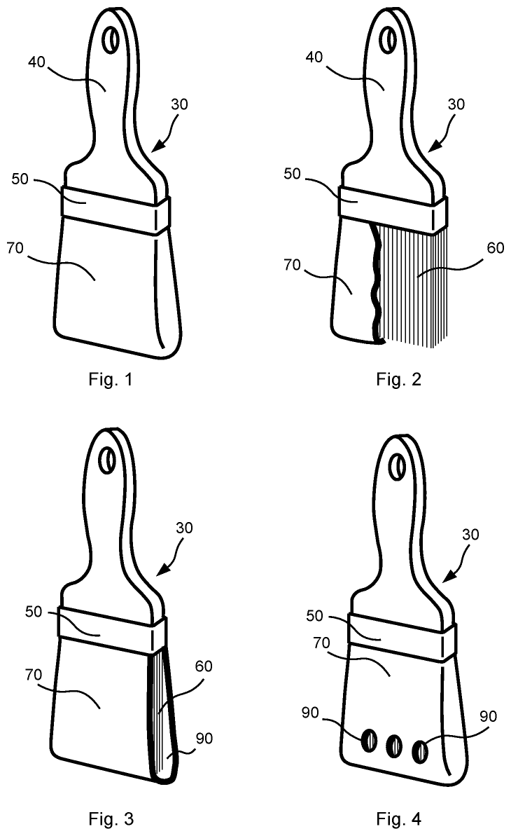

Referring to FIG. 1 and FIG. 2 one of the embodiments of microfiber jacket paint brush 30 comprises handle 40, fasten means 50; bristles 60 and microfiber cloth 70, wherein the microfiber cloth 70 wraps bristles 60 and is attached to fasten means 50 together with bristles 60. The bristles 60 may also be called as filament in the field of brush making. The material of bristle would be understood by a person having ordinary skill in the art of making brush that it can be natural animal hairs, plant fibers, or synthetic material such as acrylic, polyester, or nylon. The means to attach microfiber cloth 70 to the fasten means 50 can be by many ways such as but not limited to adhesive sealing, crimping, clamming, welding, sewing, plugging, or ferrule. The material of microfiber cloth 70 can be synthetic fine fiber made from polyesters, polyamides, or a conjugation of polyester, polyamide, and polypropylene.

Referring to FIG. 3 and FIG. 4, one of the preferred embodiments of the paint brush with microfiber cloth 70 has a plurality of openings 90 formed through and on the front, back, or lateral sides of microfiber cloth 70 to allow paint absorbing and paint flow.

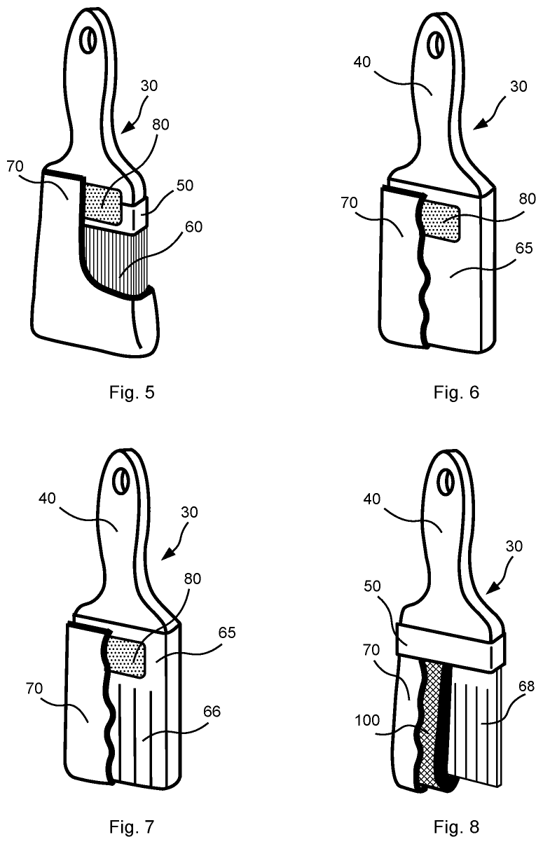

Referring to FIG. 5, one of the embodiments of the paint brush with microfiber cloth 70 comprises handle 40, fasten means 50, a plurality of bristles 60 and microfiber cloth 70, wherein the microfiber cloth 70 wraps bristles 60 and the microfiber cloth 70 is secured to fasten means 50 by the fastening and detaching means 80. The fastening and detaching means 80 can be the bonding substance and/or mechanics commonly used to fasten things to another, such as but not limited to clamp, clip, gripper, magnet, C-shape flexible clip, hook and loop fastener, spring, elastic band, wire tie, adhesive, fasteners, nails, staples, fasten means. The material of the fastening and detaching means 80 can be commonly used material, such as but not limited to metal, wood, stone, glass, adhesive, wire, thread, ties, twist ties, fiber, rubber, synthetic rubber, plastic, resin, fiberglass, or engineered polymer products, or combination thereof.

Referring to FIG. 6, one of the embodiments of the paint brush with microfiber cloth 70 comprises handle 40, flexible strip 65, wherein the microfiber cloth 70 wraps flexible strip 65 and affixed to flexible strip 65 by the fastening and detaching means 80. Flexible strip 65 can be attached to handle with fasten means or without fasten means and microfiber cloth 70 can be affixed to fasten means or flexible strip or handle or to combination thereof. Flexible strip 65 with the handle 40 can be made as a whole one part. The material of the flexible strip 65 can be commonly used material, such as but not limited to silicone, rubber, synthetic rubber or engineered polymer products, or combination thereof.

Referring to FIG. 7, one of the embodiments of the paint brush with microfiber cloth 70 comprises handle 40, flexible strip 65, wherein the microfiber cloth 70 wraps flexible strip 65 and affixed to strip 65 or detached from strip 65 by the fastening and detaching means 80 and tip end of flexible strip 65 is split into multiple sections 66 for better flexibility.

Referring to FIG. 8, another embodiment of the microfiber jacket paint brush 30, wherein the microfiber jacket paint brush 30 further comprises a layer of microfiber 100 disposed between the microfiber cloth 70 and a plurality of flexible plastic 68. The layer of microfiber 100 is thicker than the microfiber cloth 70 but has a density lower than the microfiber cloth 70. In one embodiment, it is prefer that the layer of microfiber 100 is at least two times thicker than the microfiber cloth 70, and the layer of microfiber 100 has a density measured by gram per square meter at least two times lower than the microfiber cloth 70. In the market, the density of microfiber may be normally ranged from 0.001 gram per square meter to 1,000 gram per square meter or greater, but it could be manufactured to lower or higher density. The layer of microfiber 100 can be replaced with porous fiber, which is fiber with pores on the surface of the fiber with a pore size that may range from 1 microns to greater than 200 microns. The plurality of flexible plastic 68 can be substituted with a plurality of flexible strips 65 or a plurality of bristles 60.

What is claimed is:

1. A microfiber jacket paint brush comprising:
a handle;
a fasten means attached to the handle;
a plurality of bristles secured with the fasten means; and
a microfiber cloth configured to enclose the plurality of bristles, wherein the microfiber cloth is configured attached to the fasten means and/or the handle.

2. The microfiber jacket paint brush of claim 1, wherein a plurality of openings are formed through the microfiber cloth.

3. The microfiber jacket paint brush of claim 1, wherein the microfiber cloth can be attached or detached from the fasten means by a fastening and detaching means.

4. The microfiber jacket paint brush of claim 1, further comprising a layer of porous fiber disposed between the plurality of bristles and the microfiber cloth.

5. The microfiber jacket paint brush of claim 1, further comprising a layer of microfiber disposed between the plurality of bristles and the microfiber cloth, wherein the layer of microfiber is thicker than the microfiber cloth, and wherein the layer of microfiber has a lower density than the microfiber cloth.

6. The microfiber jacket paint brush of claim 1, further comprising a layer of porous fiber disposed between the plurality of bristles and the microfiber cloth, wherein the layer of porous fiber is thicker than the microfiber cloth, and wherein the layer of porous fiber has a lower density than the microfiber cloth.

7. A microfiber jacket paint brush comprising:
a handle;
a fasten means attached to the handle;
a plurality of flexible strips secured with the fasten means; and
a microfiber cloth configured to enclose the plurality of flexible strips, wherein the microfiber cloth is configured attached to the fasten means and/or the handle.

8. The microfiber jacket paint brush of claim 7, wherein each of the plurality of flexible strip further comprises a tip end, and wherein the tip end of the flexible strip is split into multiple sections.

9. The microfiber jacket paint brush of claim 7, wherein the microfiber cloth can be attached or detached from the fasten means by a fastening and detaching means.

10. The microfiber jacket paint brush of claim 7, further comprising a layer of microfiber disposed between the plurality of flexible strips and the microfiber cloth, wherein the layer of microfiber is thicker than the microfiber cloth, and wherein the layer of microfiber has a lower density than the microfiber cloth.

11. The microfiber jacket paint brush of claim 7, further comprising a layer of porous fiber disposed between the plurality of flexible strips and the microfiber cloth, wherein the layer of porous fiber is thicker than the microfiber cloth, and wherein the layer of porous fiber has a lower density than the microfiber cloth.

12. A microfiber jacket paint brush comprising:
a handle;
a fasten means attached to the handle;
a plurality of flexible plastic secured with the fasten means; and
a microfiber cloth configured to enclose the plurality of bristles, wherein the microfiber cloth is configured attached to the fasten means and/or the handle.

13. The microfiber jacket paint brush of claim 12, further comprising a layer of porous fiber disposed between the plurality of flexible plastic and the microfiber cloth, wherein the layer of porous fiber is thicker than the microfiber cloth, and wherein the layer of porous fiber has a lower density than the microfiber cloth.

14. The microfiber jacket paint brush of claim 12, further comprising a layer of porous fiber disposed between the plurality of plastic and the microfiber cloth, wherein the layer of porous fiber is thicker than the microfiber cloth, and wherein the layer of porous fiber has a lower density than the microfiber cloth.
